(19) United States
(12) Patent Application Publication
(10) Pub. No.: US 2024/0191804 A1
(43) Pub. Date: Jun. 13, 2024

(54) PINCH VALVE AND A PROCESS FOR THE PRODUCTION OF A PINCH VALVE

(71) Applicant: AKO Armaturen & Separationstechnik GmbH, Trebur-Astheim (DE)

(72) Inventor: Frederic KOPP, Mainz (DE)

(21) Appl. No.: 18/529,350

(22) Filed: Dec. 5, 2023

(30) Foreign Application Priority Data
Dec. 7, 2022 (DE) 102022132587.3

(51) Int. Cl. F16K 7/07

(52) U.S. Cl. CPC F16K 7/07; F16K 7/061

(57) ABSTRACT

A pinch valve having a valve housing, wherein the valve housing has a valve inlet and a valve outlet and a sleeve arranged between the valve inlet and the valve outlet, wherein the sleeve is connected to the valve inlet and the valve outlet and forms a valve channel, which valve channel can be flowed through in a conveyed direction by a conveyed medium, wherein the pinch valve further has a pinch bar, which moves back and forth in a closing direction between an open position and a closed position, wherein the pinch bar is in contact with the sleeve at least in the closed position, such that the pinch bar exerts a closing force on the sleeve in the closing direction, such that a channel cross-section of the valve channel perpendicular to the conveyed direction between the valve inlet and the valve outlet can be reduced and/or closed, wherein the sleeve has at least two material layers between which a first textile fabric, preferably a mesh, is arranged.

### FIELD OF THE INVENTION

The present invention relates to a pinch valve and a process for the production of a pinch valve. Valves are generally used for the temporary closure or throttling of a conveyed medium or product flow. These product flows, which can, for example, consist of gases, dusts, liquids, solids or suspensions and other materials, flow through the valve in one conveyed direction when the valve is open. Compared to most other types of valve, pinch valves offer the advantage that they also provide a complete seal when a product flow is shut off, which product flow can consist of solid components, such as granules, powders or pastes.

### BACKGROUND OF THE INVENTION

In general, pinch valves have a valve housing, which has a valve inlet and a valve outlet, and a sleeve arranged between the valve inlet and the valve outlet. The sleeve is connected to the valve inlet and the valve outlet such that a valve channel is formed, through which valve channel a conveyed medium can flow in the conveyed direction.

In order to interrupt the flow of the pumped medium, some pinch valves additionally have a pinch bar, which moves back and forth in a closing direction between an open position and a closed position, whereby said pinch bar is in contact with the sleeve at least in the closed position such that a closing force is exerted on the sleeve by the pinch bar in the closing direction. This reduces and/or closes a channel cross-section of the valve channel perpendicular to the conveyed direction between the valve inlet and the valve outlet, so that the conveyed medium can only pass through the pinch valve to a limited extent or not at all. There are also pinch valves with a control chamber enclosing the sleeve, which control chamber can be supplied with compressed air in order to compress the sleeve. In this case, the pinch bar can be omitted. However, such pinch valves are not suitable for all types of product flow.

The closing force, which needs to be applied to close the pinch valve with the aid of the pinch bar, is dependent, on the one hand, on the medium being conveyed and the operating pressure and, on the other hand, on the material and construction of the sleeve and the pinch bar.

The closing force, which the pinch bar must exert on the sleeve, is correspondingly high in particular, if a medium with solid components is to be conveyed. It is therefore desirable to keep the inherent closing force, which is exerted by the pinch bar onto the sleeve, as low as possible when no medium is being conveyed in the pinch valve. Moreover, the lowest possible inherent closing force is also advantageous for economic reasons, as the manufacturing costs and also the operating costs of a drive for the pinch bar increase the more force must be applied by the drive.

Various solutions from the prior art are known for efficient closability. One solution, for example, is that a gradient is provided in the valve housing opposite the pinch bar, which gradient continuously tapers the cross-section of the valve channel. This measure reduces the distance of the pinch bar to the closed position. However, this design has the disadvantage that the conveyance of the medium in the area of the gradient is permanently impaired due to the constant reduction of the cross-section. The medium can become stuck and the flow can be reduced as a result.

### SUMMARY OF THE INVENTION

The present invention is based on the object of providing a pinch valve or a process for the production of a pinch valve, which has a reduced closing force compared to pinch valves known from the prior part without using a continuous tapering of the channel cross-section.

The object underlying the invention is achieved by a pinch valve of the type mentioned above, wherein the sleeve consists of a minimum of two material layers, between which layers a first textile fabric, preferably a mesh, is arranged.

Due to the arrangement of the first textile fabric between the material layers of the sleeve, the material layers can be designed with a thinner material thickness, as the first textile fabric increases the stability of the sleeve. By reducing of the material thicknesses, the pinch bar ultimately requires less force to reduce the channel cross-section, as the counter-force of the sleeve is lower.

According to the invention, the sleeve is constructed from a minimum of two layers of material. An inner material layer, which is in direct contact with the conveyed medium, is designated as the inner cover, while an outer material layer, which is not in direct content with the conveyed medium, is designated as the outer cover.

In one embodiment, the material thickness of the inner material layer, i.e. the inner cover, is less than the material thickness of the outer material layer. The outer material layer of the sleeve, the so-called outer cover, thus makes up the greater pro-portion of the total wall thickness of the sleeve.

The inner material layer (inner cover) is made in particular from an elastomer, which either exhibits very good chemical compatibility to the conveyed medium or, in the case that no chemical compatibility is required, exhibits high abrasion resistance in order to avoid early wear due to abrasion. Typical materials used for the inner layer include, for example, nitrile rubber, chloroprene rubber, chlorosulfonated polyethlene, butyl rubber, fluoroelastomer, fluorocarbon, or silicone. The inner material layer thus essentially contributes to the chemical resistance of the sleeve.

The outer material layer contributes significantly to the function of the sleeve and in one embodiment is also made of an elastomer. The elastomer is selected in such a way that the outer material layer is sufficiently elastic and thus has sufficient tensile strength and tear resistance to achieve the longest possible service life under the permanent dynamic load caused by the pinch bar. Typical materials for the outer material layer are, for example, natural rubber or ethylene propylene diene rubber (EPDM).

The elasticity of the sleeve according to the invention leads to the sleeve according to the invention completely dispensing with a direct connection between the pinch bar and the sleeve, as the sleeve opens again to a circular cross-section after the pinch bar has opened, and the conveyed medium can flow freely again.

Depending on the operating conditions under which the pinch valve according to the invention is operated, an additional opening of the sleeve with a pinch valve sleeve pull open unit can be omitted. The operating conditions that significantly determine the opening behaviour of the sleeve are primarily the prevailing ambient temperatures, the temperature or other properties of the conveyed material itself passing through the pinch valve, as well as the pressure conditions in the valve channel and around the pinch valve.

In one application in the valve channel of the pinch valve according to the invention there is, for example, a vacuum in order to convey the mixed material. In this case, a pinch valve sleeve pull open unit is required, as the inherent restoring force of the sleeve, after the pinch bar has been moved to the open position, is not sufficient to return the channel cross-section to its original size. However, a pinch valve sleeve pull open unit can also be advantageous in other applications if the inherent restoring force of the pinch valve sleeve is not sufficient to restore the full open cross-section.

In one embodiment, the pinch valve therefore further consists of a pinch valve sleeve pull open unit for the sleeve, wherein the pinch valve housing is designed gas-tight, wherein the pinch valve sleeve pull open unit is designed in such a way that the pinch valve sleeve pull open unit can generate a vacuum in the valve housing, so that the sleeve is pulled against a housing wall of the pinch valve housing and the channel cross-section is enlarged. Alternatively, the pinch valve sleeve pull open unit can also be designed so that the pinch valve sleeve pull open unit can generate a vacuum in the valve housing, which pinch valve housing counteracts the forces due to the vacuum in the pinch valve channel.

In one embodiment, the sleeve has a central section and a first and a second end section, which are arranged in tandem in the conveyed direction. In this case, the first textile fabric does not extend to the first end section and preferably also not to the second end section. Further, a clamping device with two clamping surfaces is provided, with which clamping device the sleeve is attached to the valve inlet and or the valve outlet in such a way that the first end section is clamped between the two clamping surfaces, wherein particularly preferably the central section is not or only an edge section of the central section is clamped between the clamping surfaces. Consequently, the first textile fabric preferably does not extend between the two clamping surfaces of the clamping device. At the most, only a small edge area of the first textile fabric is arranged between the clamping surfaces. This additionally increases the flexibility of the sleeve according to the invention, reduces the required closing force of the pinch bar or the drive and, at the same time, minimises the force required to mount the sleeve between the clamping surfaces of the valve inlet or outlet.

In particular, the clamping device in one embodiment has a conical section, wherein a diameter of the conical section tapers toward the interior of the valve channel, wherein an outer surface of the conical section forms a first clamping surface, which clamping surface forms an angle of at least 10° and at most 35° with the conveyed direction and wherein the conical section is designed such that the conical section presses a wall of the sleeve against a second clamping surface, which is arranged in the valve housing. The angle of the conical section subjected to stress means that the sleeve is not subjected to too much stress by the clamping device. Further, the selected angle prevents a bead forming between a cone tip and the sleeves if too large angle is selected. Ultimately, an edge between the cone tip and the sleeve is also smaller, whereby less conveyed material can settle and contaminate the pinch valve according to the invention. This also simplifies the cleaning of the pinch valve according to the invention. In particular, the pinch valve can also be cleaned using a pig, i.e. a fitting body that can be used in the sleeve or in the connected pipes.

Particularly preferably, the clamping device further has a connecting section, via which connecting section the valve channel of the pinch valve can be connected to a supply line. For this purpose, the connecting section has, for example, an internal thread, tri-clamp, a pipe welding end, a flange or other connections that meet the corresponding hygiene requirements. It is understood that the valve inlet and outlet can be connected to supply lines via different connection sections of the clamping device. In particular, in a further embodiment, the conical section and the connecting section are designed as a single section to facilitate the clamping of the sleeve and further to produce the clamping device more economically.

In a further embodiment, the sleeve has a minimum of one first, one second and one third material layer and a second textile fabric, preferably a mesh, wherein the first textile fabric is arranged between the second and third material layer, and the second textile fabric is arranged between the first and second material layer, wherein the first material later preferably adjoins the valve channel, the second material layer is arranged further away from the valve channel than the first material layer, and the third material layer is arranged further away from the valve channel than the second material layer. In other words, either the inner textile fabric as viewed from the valve channel is not clamped between the clamping surfaces or the outer textile fabric as viewed from the valve channel. This permits, on the one hand, a stable clamping of the sleeve in the valve housing and, on the other hand, sufficient flexibility of the sleeve, as not each of the textile fabrics extends as far as the clamping device. The provision of two textile fabrics improves the pressure stability of the sleeve. The inner textile fabric, as seen from the valve channel, is preferably clamped between the clamping surfaces.

In a further embodiment, the pinch bar has a cross-section perpendicular and/or parallel to the conveyed direction, which tapers in the closing direction. Only a smaller surface of the pinch bar thus contacts the sleeve. If the pinch bar continues to move in the closing direction, the sleeve will bulge around the pinch bar. The clamping force can thus be reduced in contrast to a pinch bar, which presses vertically onto the sleeve over the full width of its cross-section. A uniform contact pressure is thus applied to the sleeve by the pinch bar, and the closing force remains constant during the closing process. Ultimately, a pinch bar with a tapered cross-section also requires less space in the valve housing, and so the pinch valve according to the invention can be designed to be more compact, lighter and more cost-effective. Furthermore, the flow of the conveyed medium can be regulated more specifically.

In a further embodiment, the valve housing is also adapted to the shape of the pinch bar, so that the cavities are reduced between one housing wall of the valve housing and the sleeves. This, in turn, reduces the load on the sleeve by minimising expansion into the cavities, extending the life of the sleeve.

In particular, the pinch bar has a triangular cross-section perpendicular and/or parallel to the conveyed direction at least in sections, wherein the triangular cross-section is orientated such that one contact tip of the three tips of the triangular cross-section points in the closing direction, wherein the contact tip is preferably rounded with a radius. Alternatively, the contact tip has a contact surface which is orientated essentially perpendicular to the closing direction and in each case transitions via a curve into the side surfaces of the triangular cross-section.

The rounding or flattening of the contact tip reduces damage to the sleeve when it comes into contact with the pinch bar. In addition, the triangular cross-section means that the clamping force exerted by the pinch bar on the sleeve is reduced, as the side surfaces of the pinch bar, which connect to the contact tip, exert a clamping force on the sleeve at an angle of less than 90°.

Further, in one embodiment, a radius Rₛ of the contact tip of the triangular cross-section perpendicular to the conveyed direction is a minimum of 5 mm and a maximum of 20 mm, preferably a minimum of 7 mm and a maximum of 18 mm and/or wherein a radius Rₚ of the contact tip of the triangular cross-section parallel to the conveyed direction is a minimum of 2 mm and a maximum of 10 mm, preferably a minimum of 3 mm and a maximum of 7 mm. The selected radius means that the pinch valve can be closed with sufficient accuracy and, at the same time, the sleeve is damaged as little as possible by the pinch bar, even with repeated closing operations.

In a further embodiment, an opening angle at the contact tip of the triangular cross-section perpendicular to the conveyed direction is a minimum of 85° and a maximum of 95°, and/or wherein an opening angle at the contact tip of the triangular cross-section parallel to the conveyed direction is a minimum of 35° and a maximum of 65°. In this way, the force exerted on the sleeve from the sides of the triangle can be regulated.

In a further embodiment, the pinch bar has a triangular cross-section perpendicular to and parallel to the conveyed direction, wherein the contact tip of the triangular cross-section perpendicular to the conveyed direction has a radius Rₛ, wherein the contact tip of the triangular cross-section parallel to the conveyed direction has a radius Rₚ, where Rₛ≠Rₚ.

In a further embodiment, the pinch bar has a triangular cross-section perpendicular to and parallel to the conveyed direction, wherein the contact tip of the triangular cross-section perpendicular to the conveyed direction has an opening angle, wherein the contact tip of the triangular cross-section parallel to the conveyed direction has an opening angle, where ≠.

In other words, the cross-section of the pinch bar perpendicular to the conveyed direction differs from the cross-section parallel to the conveyed direction. This allows the cross-section of the pinch bar to be optimally adapted to the different bending properties of the sleeve in the conveyed direction or perpendicular to the conveyed direction.

In a further embodiment, a drive is provided to actuate the pinch bar in the closing direction, wherein preferably the drive is a pneumatic drive. In principle, however, manual drives by means of a handwheel or a hydraulic drive and also an electric drive are also conceivable.

In particular, in one embodiment an opening is further provided in the valve housing via which a pressure in the valve housing can be adjusted. This has the advantage that the sleeve can be closed if the drive fails completely. In addition, the opening can also be used to attach various sensors, e.g. pressure sensors, which can detect a leakage of the sleeve. In particular, a vacuum can also be generated in the valve housing via the opening, which vacuum serves to pull open the sleeve.

In a further embodiment, the drive and the pinch bar are arranged in the valve housing, wherein preferably the valve housing is designed gas-tight. This is particularly advantageous if the drive is a pneumatic drive. A gas-tight design further has the advantage that the valve according to the invention is also suitable for vacuum applications and a leakage of the sleeve can be easily detected. Due to the gas-tight design, the closing mechanism of the pinch valve is not impaired by a vacuum surrounding the pinch valve. A leak is further indicated by a change in pressure in the valve housing and can thus be detected by simple sensors.

In particular, the valve housing in one embodiment is made of a metal, preferably of aluminium or stainless steel and preferably of a die cast or a stainless steel casting. It is understood, however, that depending on the application profile of the pinch valve, an injection moulding process for the production of a pinch valve made of plastic is also conceivable.

In a further embodiment, at least some sections of the pinch bar have a coating which is arranged on a contact surface of the pinch bar, which contact surface comes into contact with the sleeve. The coating, which is, for example a PTFE or Teflon coating, offers the advantage that the adhesive friction between the pinch bar and the sleeve is reduced and thus damage to the sleeve is additionally reduced. Furthermore, the closing force is reduced if the adhesive friction is reduced.

In a further embodiment, the valve housing has a cavity between the valve inlet and the valve outlet by the arrangement of the sleeve, wherein the cavity is delimited by a housing wall, wherein the housing wall has a plurality of ribs, preferably a minimum of 4 and a maximum of 10 ribs, which extend perpendicular to the conveyed direction from the housing wall in the direction of the sleeve into the cavity, wherein particularly preferably a total length of the ribs in the conveyed direction corresponds to a minimum of 35%, preferably a minimum of 40% of the total length of the cavity in the conveyed direction. The distance between two adjacent ribs is preferably a minimum of 4 mm and a maximum of 20 mm.

The ribs facilitate the pressure-stable bearing of the sleeve in the cavity of the valve housing. At the same time, at higher operating pressures of the conveyed medium, the ribs prevent inflation or bloating of the sleeve in the cavity of the valve housing and thus reduce unnecessary loads on the sleeve during operation of the pinch valve.

The ribs of the valve housing are therefore designed in one embodiment in such a way that the distance of the ribs in the conveyed direction is so small that inflation or bloating of the sleeve is not possible. In particular, all edges of the ribs are rounded to prevent damage to the sleeve.

Furthermore, the ribs benefit the production of the pinch valve according to the invention, as the walls of the valve housing can be made slimmer with unvarying stability and thus prevent an accumulation of material, and potential voids as well as leaks in the cast structure.

The object underlying the invention is further achieved by a process for the production of a pinch valve, wherein the pinch valve has a valve housing, wherein the valve housing has a valve inlet and a valve outlet and a sleeve arranged between the valve inlet and the valve outlet, wherein the sleeve is connected to the valve inlet and the valve outlet and forms a valve channel, which can be flowed through by a medium in a conveyed direction, wherein the pinch valve further has a pinch bar, which moves back and forth in the closing direction, wherein the pinch bar is in contact with the sleeve such that a closing force can be exerted on the sleeve in the closing direction by the pinch bar, so that the channel cross-section of the valve channel perpendicular to the conveyed direction can be reduced and/or closed between the valve inlet and the valve outlet, wherein the sleeve has at least two material layers, between which material layers a first textile fabric, preferably a mesh, is arranged and the sleeve is manufactured in a winding process.

A winding process provides a cost-effective production option for the multi-layer sleeve. In particular, a plurality of sleeves can be produced in a manufacturing process in that the textile fabrics are at a spacing from each other along a longitudinal axis of a sleeve blank, which corresponds to the subsequent conveyed direction, which spacing corresponds to the length of the subsequent sleeve. After the sleeve blank has been produced in the winding process, the sleeve blank is divided into several sections, which represent the actual sleeve for the pinch valve according to the invention.

In addition, the winding process offers a high degree of flexibility in the design of the inner cover and outer cover as well as the insertion of the various textile fabrics.

It is understood that the process for the production of a pinch valve is used to produce in particular a pinch valve according to one of the aforementioned embodiments. In particular, in one embodiment of the process according to the invention, the valve housing is manufactured from metal or plastic in a casting process. This enables the pinch valve according to the invention to be produced as particularly stable and with low weight.

### BRIEF DESCRIPTION OF THE DRAWINGS

Further advantages, features and application possibilities of the present invention will be made clear by means of the following description of various embodiments and the associated figures. The same components are provided with the same reference symbols.

FIG. 1a shows a schematic representation of a cross-section parallel to the conveyed direction by a first embodiment of the present invention.

FIG. 1b shows an enlargement of the area of the sleeve, which is shown in FIG. 1a.

FIG. 2 shows a cross-section perpendicular to the conveyed direction of the embodiment of the pinch valve according to the invention shown in FIGS. 1a and 1b.

FIG. 3 shows a cross-section perpendicular to the conveyed direction for a second embodiment of the pinch valve according to the invention.

FIG. 4a shows a cross-section perpendicular to the conveyed direction of a partially closed state of the embodiment of the pinch valve shown in FIG. 3.

FIG. 4b shows a cross-section parallel to the conveyed direction of a partially closed state of the embodiment of the pinch valve shown in FIG. 3.

FIG. 5 shows a partial cross-section perpendicular to the conveyed direction of a third embodiment of the pinch valve according to the invention.

FIG. 6 shows a three-dimensional external view of the embodiment of the pinch valve according to the invention shown in FIG. 5.

### DETAILED DESCRIPTION OF THE INVENTION

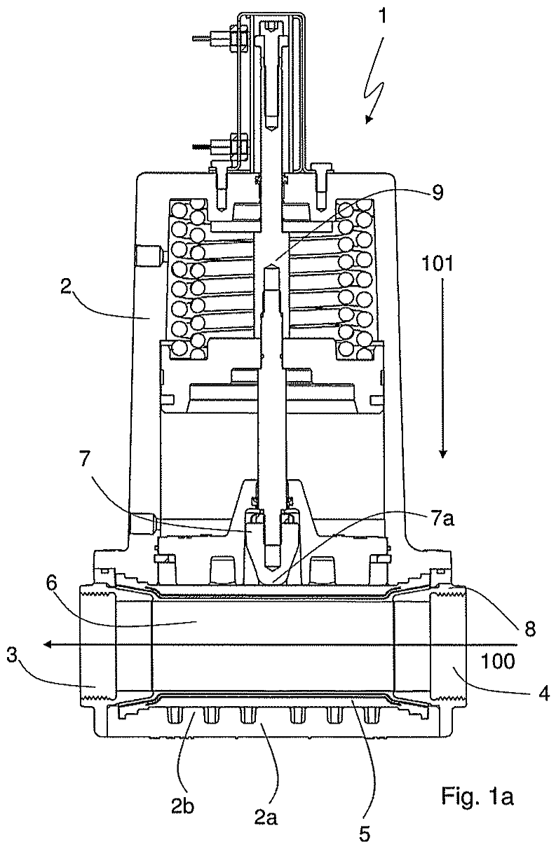

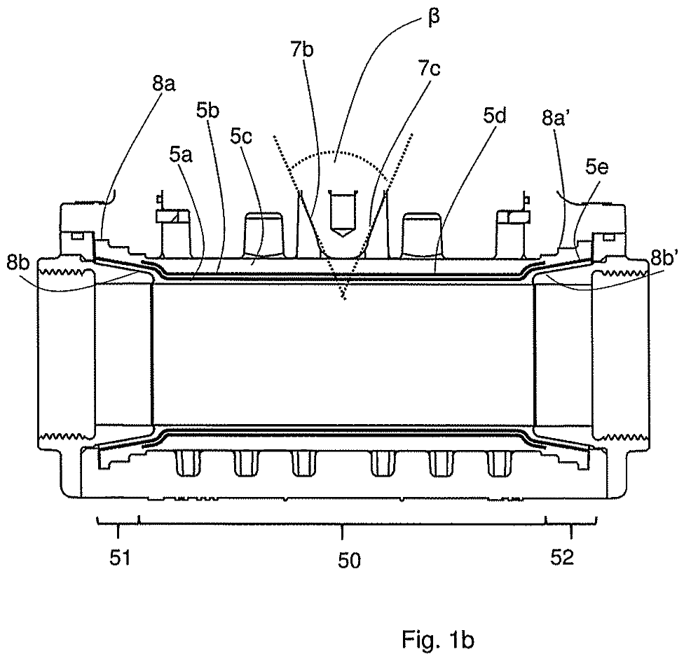

The embodiment of the pinch valve 1 according to the invention shown in FIG. 1a has a valve housing 2, wherein the valve housing 2 has a valve inlet 3 and a valve outlet 4 and a sleeve 5 arranged between the valve inlet 3 and the valve outlet 4. The sleeve 5 connects the valve inlet 3 to the valve outlet 4 and forms a valve channel 6, which can be flowed through by a conveyed medium in the conveyed direction 100.

The sleeve 5 is mounted in a cavity of the valve housing 2, wherein the valve housing has ribs 2b, which extend from the housing wall 2a in the direction of the cavity and on which ribs the sleeve 5 is mounted.

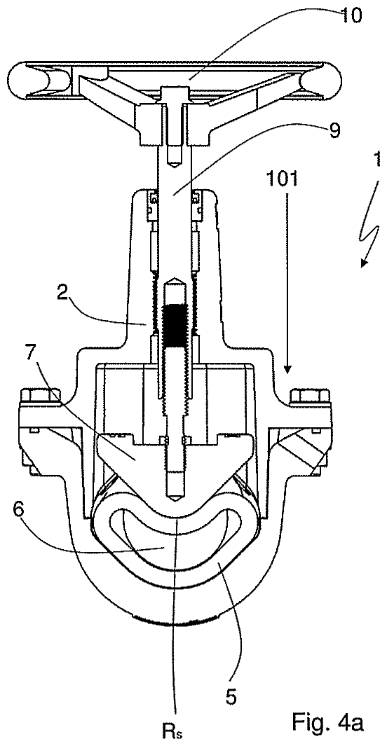

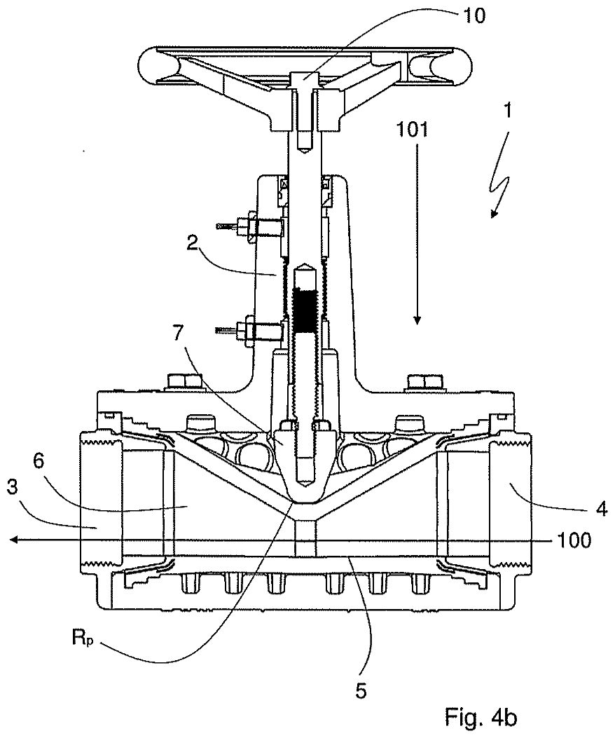

In order to close the pinch valve 1 in a closing direction 101 perpendicular to the conveyed direction 100, the pinch valve 1 has a pinch bar 7, which moves back and forth between an open and closed position, wherein said pinch bar 7 is in contact with the sleeve 5 at least in the closed position such that a closing force is exerted on the sleeve 5 by the pinch bar 7 in the closing direction 101. In the embodiments shown in FIGS. 1 to 3, the pinch bar is in the open position in which no force is exerted on the sleeve 5. FIGS. 4a and 4b, on the other hand, show a state in which the pinch bar 7 exerts a closing force on the sleeve 5. The sleeve 5 is pinched accordingly and the cross-section of the valve channel 6 is reduced.

As shown in detail in FIG. 1b, the sleeve 5 has a first material layer 5a, a second material layer 5b and a third material layer 5c, wherein the first material layer 5a directly adjoins the valve channel 6 and the third material layer 5c is furthest away from the valve channel 6. A first textile fabric 5d is arranged between the third material layer 5c and the second material layer 5b, and a second textile fabric 5e is arranged between the second material layer 5b and the first material layer 5a.

Furthermore, the sleeve 5 is divided into a central section 50 and a first and a second end section 51, 52, which are arranged in tandem in the conveyed direction 100. The first end section 51 of the sleeve 5 is connected to the valve inlet 3 between two clamping surfaces 8a, 8b of a clamping device 8. Furthermore, the second end section 52 is connected to the valve outlet 4 between two clamping surfaces 8a′ and 8b′ of a clamping device 8. As is also clear in FIG. 1b, that the first textile fabric 5d does not extend to the first end section 51 and not to the second end section 52. In contrast, the second textile fabric 5e extends both into the first end section 51 and also into the second end section 52, so that the second textile fabric 5e is clamped between the clamping surfaces 8a, 8b and 8a′, 8b′, while the clamping surfaces 8a, 8b, 8a′, 8b′ clamp only an edge section of the central section 50, and thus of the first textile fabric 5d.

This leads to a closing force, which must be exerted from the pinch bar 7 onto the sleeve 5 to close the pinch valve 1, being reduced in comparison to an embodiment in which the first textile fabric would extend as far as the clamping device 8.

Furthermore, the shape of the pinch bar 7 can be taken from the cross-sections shown perpendicular and parallel to the conveyed direction 100, which shape further reduces the closing force of the pinch valve according to the invention.

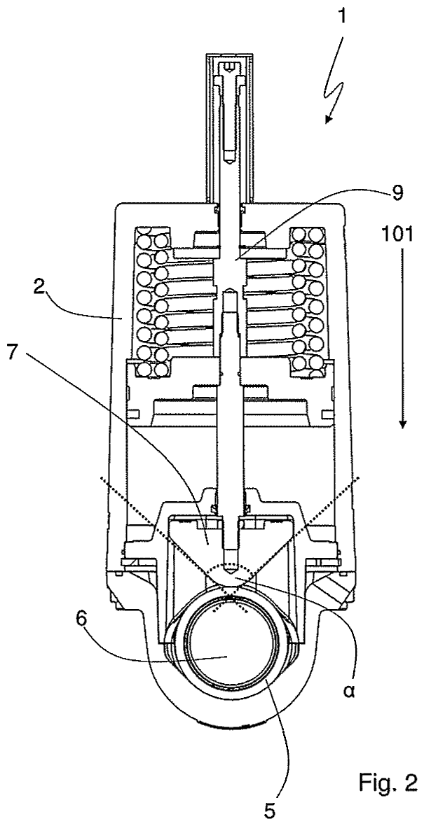

In the cross-section perpendicular to the conveyed direction (see FIGS. 2, 3 and 4a), the pinch bar has a triangular cross-section, wherein the triangular cross-section is orientated such that one contact tip 7a of the three tips of the triangular cross-section points in the closing direction 101. The contact tip 7a is rounded with a radius Rₛ of 15 mm in a direction perpendicular to the conveyed direction. An opening angle in a plane perpendicular to the conveyed direction at the contact tip 7a of the triangular cross-section is 90°.

In addition, it can be seen from the longitudinal section along the conveyed direction 100 shown in FIG. 1b that the pinch bar 7 also has a cross-section parallel to the conveyed direction 100, which cross-section tapers in the closing direction 101. If the sides of the cross-section of the pinch bar are extended virtually (see dashed lines in FIG. 1b), then they can be described as a triangle with an opening angle of 42°. It is further apparent from the longitudinal section shown in FIG. 1b that the contact tip 7a is flattened and forms a contact surface perpendicular to the closing direction 101. The contact surface transitions with a rounding radius Rₚ of 21° in each case into the side surfaces 7b, 7c of the pinch bar.

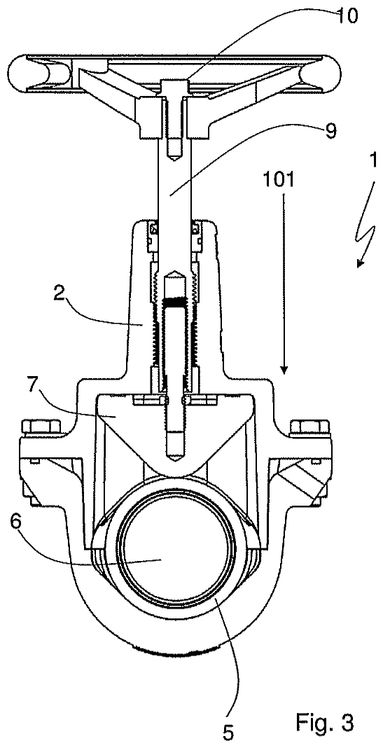

In order to move the pinch bar 7 in the closing direction 101, a drive 9 is provided in the embodiment shown in FIGS. 1a and 2, which drive moves the pinch bar 7 in the closing direction 101 onto the sleeve 5. The drive 9 is arranged in the valve housing 2 of the pinch valve 1. In contrast, a manual drive by means of a handwheel 10 is shown in FIGS. 3, 4a and 4b, wherein the handwheel 10 protrudes from the valve housing 2 for actuation.

The valve housing shown in the figures is manufactured in a chill casting and investment casting process and is gas-tight. The sleeve 5 is also manufactured in a winding process.

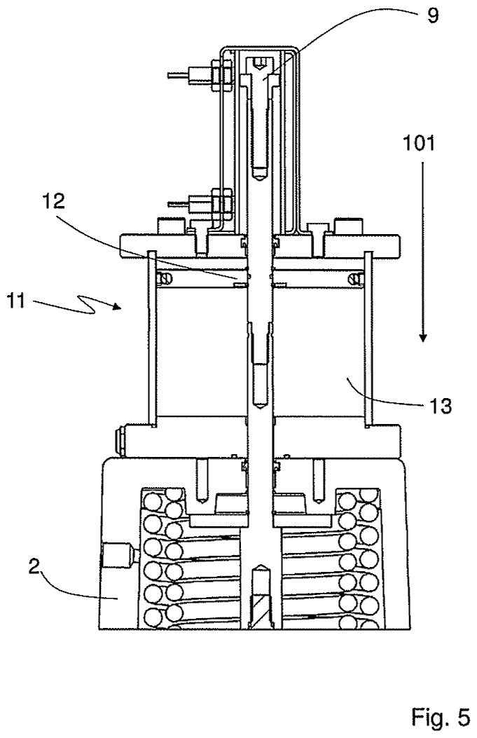

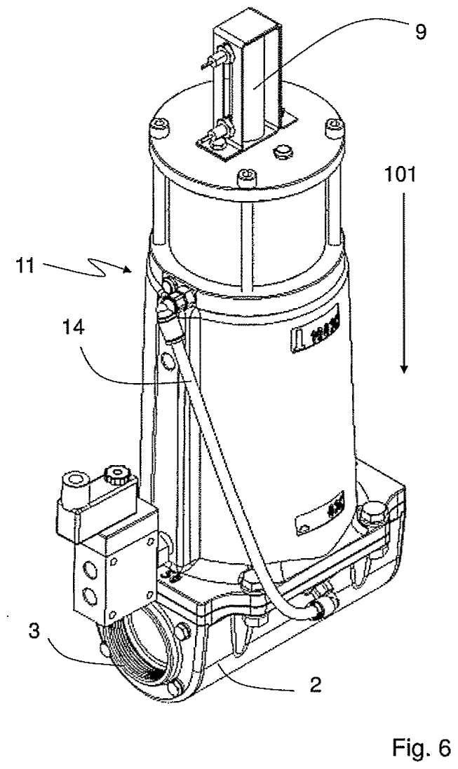

The third embodiment of the pinch valve 1 according to the invention shown in FIGS. 5 and 6 essentially corresponds to the embodiment shown in FIGS. 1a and 2. However, the pinch valve 1 has an additional sleeve pull open unit 11, with which sleeve pull open unit the sleeve 5 is actively pulled into an open position. A piston 12 of the sleeve pull open unit 11 is connected to the drive 9 for this purpose, so that a movement of the piston 12 of the sleeve pull open unit 11 is coupled with a movement of the drive 9.

If the drive 9 moves the pinch bar 7 into the open position, a vacuum is generated in a chamber 13 of the sleeve pull open unit 11 by the movement of the piston 12. The chamber 13 is connected to the cavity of the valve housing 2 via a line 14, so that a vacuum is thereby generated in the cavity of the valve housing 2 and the sleeve 5 is pulled open in this way.

This is advantageous if, for example, a vacuum is produced in the valve channel 6 in order to transport the conveyed medium. Then the force of the vacuum generated by the sleeve pull open unit 11 in the cavity counteracts the force of the vacuum in the valve channel 6, so that the sleeve 5 is fully opened again after closing and the conveyed medium can pass through unhindered.

### REFERENCE SYMBOLS

1 Pinch valve
2 Valve housing
2a Housing wall
2b Ribs
3 Valve inlet
4 Valve outlet
5 Sleeve
5a First material layer
5b Second material layer
5c Third material layer
5d First textile fabric
5e Second textile fabric
6 Valve channel
7 Pinch bar
7a Contact tip
7b, 7c Side surfaces of the pinch bar
8 Clamping device
8a, 8b, 8a′, 8b′ Clamping surfaces
9 Drive
10 Handwheel
11 Sleeve pull open unit
12 Piston
13 Chamber
14 Line
50 Central section
51 First end section
52 Second end section
100 Conveyed direction
101 Closing direction

What is claimed is:

1. A pinch valve, comprising:
a valve housing, wherein the valve housing has a valve inlet and a valve outlet and a sleeve arranged between the valve inlet and the valve outlet, wherein the sleeve is connected to the valve inlet and the valve outlet and forms a valve channel, which valve channel can be flowed through in a conveyed direction by a conveyed medium,
wherein the pinch valve further has a pinch bar, which moves back and forth in a closing direction between an open position and a closed position, wherein the pinch bar is in contact with the sleeve at least in the closed position, such that the pinch bar exerts a closing force on the sleeve in the closing direction, such that a channel cross-section of the valve channel perpendicular to the conveyed direction between the valve inlet and the valve outlet can be reduced and/or closed, and
wherein the sleeve has at least two material layers between which a first textile fabric, preferably a mesh, is arranged.

2. The pinch valve according to claim 1, wherein the pinch valve further comprises a pinch valve sleeve pull open unit for the sleeve, wherein the valve housing is designed gas-tight, wherein the pinch valve sleeve pull open unit is designed in such a way, that the pinch valve sleeve pull open unit can generate a vacuum in the valve housing, so that the sleeve is pulled against a housing wall of the valve housing and the channel cross-section is enlarged.

3. The pinch valve according to claim 1, wherein the sleeve has a central section and a first and a second end section, which are arranged in tandem in the conveyed direction, wherein the first textile fabric does not extend to the first end section and preferably also not to the second end section, wherein a clamping device with two clamping surfaces is provided, with which clamping device the sleeve is secured to the valve inlet and/or the valve outlet such that the first end section is clamped between the two clamping surfaces, wherein particularly preferably the central section is not clamped or only one edge section of the central section is clamped between the clamping surfaces.

4. The pinch valve according to claim 3, wherein the clamping device has a conical section, wherein a diameter of the conical section tapers toward the interior of the valve channel, wherein an outer surface of the conical section forms a first of two clamping surfaces, which first clamping surface forms an angle of a minimum of 10° and a maximum of 35° with the conveyed direction and wherein the conical section is designed such that the conical section presses a wall of the sleeve against a second of the two clamping surfaces, which clamping surface is arranged in the valve housing.

5. The pinch valve according to claim 1, wherein the sleeve comprises a minimum of a first, a second and a third material layer, and a second textile fabric, preferably a mesh, wherein the first textile fabric is arranged between the second and third material layer and the second textile fabric is arranged between the first and second material layer, wherein preferably the first material layer adjoins the valve channel, the second material layer is arranged further away from the valve channel than the first material layer and the third material layer is arranged further away from the valve channel than the second material layer, wherein particularly preferably the second textile fabric extends into the first end section and particularly preferably into the second end section.

6. The pinch valve according to claim 1, wherein the pinch bar has a cross-section perpendicular and/or parallel to the conveyed direction, which tapers in the closing direction.

7. The pinch valve according to claim 6, wherein the pinch bar has a triangular cross-section perpendicular and/or parallel to the conveyed direction at least in sections, wherein the triangular cross-section is orientated such that one contact tip of the three tips of the triangular cross-section points in the closing direction, wherein the contact tip is preferably rounded with a radius.

8. The pinch valve according to claim 7, wherein a radius Rₛ of the contact tip of the triangular cross-section perpendicular to the conveyed direction is a minimum of 5 mm and a maximum of 20 mm, preferably a minimum of 7 mm and a maximum of 18 mm and/or wherein a radius Rₚ of the contact tip of the triangular cross-section parallel to the conveyed direction is a minimum of 2 mm and a maximum of 10 mm, preferably a minimum of 3 mm and a maximum of 7 mm.

9. The pinch valve according to claim 7, wherein an opening angle α at the contact tip of the triangular cross-section perpendicular to the conveyed direction is a minimum of 85° and a maximum of 95° and/or wherein an opening angle β at the contact tip of the triangular cross-section parallel to the conveyed direction is a minimum of 35° and a maximum of 65°.

10. The pinch valve according to claim 7, wherein the pinch bar has a triangular cross-section perpendicular to and parallel to the conveyed direction, wherein the contact tip of the triangular cross-section perpendicular to the conveyed direction has a radius Rₛ, wherein the contact tip of the triangular cross-section parallel to the conveyed direction has a radius Rₚ, wherein Rₛ≠Rₚ.

11. The pinch valve according to claim 7, wherein the pinch bar has a triangular cross-section perpendicular to and parallel to the conveyed direction, wherein the contact tip of the triangular cross-section perpendicular to the conveyed direction has an opening angle α, wherein the contact tip of the triangular cross-section parallel to the conveyed direction has an opening angle β, wherein α≠β.

12. The pinch valve according to claim 1, wherein a drive to actuate the pinch bar is provided in the closing direction, wherein preferably the drive is a pneumatic drive, wherein an opening is provided in the valve housing, via which the pressure in the valve housing can be adjusted.

13. The pinch valve according to claim 1, wherein at least some sections of the pinch bar have a coating which is arranged on a contact surface of the pinch bar, which contact surface comes into contact with the sleeve.

14. The pinch valve according to claim 1, wherein the valve housing has a cavity between the valve inlet and the valve outlet in which the sleeve is arranged, wherein the cavity is delimited by a housing wall, wherein the housing wall has a plurality of ribs, preferably a minimum of 4 and a maximum of 10 ribs, which ribs extend perpendicular to the conveyed direction from the housing wall in the direction of the sleeve into the cavity, wherein a total length of the ribs in the conveyed direction corresponds to a minimum of 35%, preferably a minimum of 40% of the total length of the cavity in the conveyed direction.

15. A process for the production of a pinch valve having a valve housing, wherein the valve housing has a valve inlet and a valve outlet and a sleeve arranged between the valve inlet and the valve outlet, wherein the sleeve is connected to the valve inlet and the valve outlet and forms a valve channel, which valve channel can be flowed through in a conveyed direction by a conveyed medium, wherein the pinch valve further has a pinch bar, which moves back and forth in a closing direction, wherein the pinch bar is in contact with the sleeve, such that the pinch bar exerts a closing force on the sleeve in the closing direction, such that a channel cross-section of the valve channel perpendicular to the conveyed direction between the valve inlet and the valve outlet can be reduced and/or closed, wherein the sleeve comprises at least two material layers between which a first textile fabric, preferably a fabric, is arranged and the sleeve is produced in a winding process.

16. The pinch valve according to claim 2, wherein the sleeve has a central section and a first and a second end section, which are arranged in tandem in the conveyed direction, wherein the first textile fabric does not extend to the first end section and preferably also not to the second end section, wherein a clamping device with two clamping surfaces is provided, with which clamping device the sleeve is secured to the valve inlet and/or the valve outlet such that the first end section is clamped between the two clamping surfaces, wherein particularly preferably the central section is not clamped or only one edge section of the central section is clamped between the clamping surfaces, and wherein the clamping device has a conical section, wherein a diameter of the conical section tapers toward the interior of the valve channel, wherein an outer surface of the conical section forms a first of two clamping surfaces, which first clamping surface forms an angle of a minimum of 10° and a maximum of 35° with the conveyed direction, and wherein the conical section is designed such that the conical section presses a wall of the sleeve against a second of the two clamping surfaces, which clamping surface is arranged in the valve housing.

17. The pinch valve according to claim 16, wherein the sleeve comprises a minimum of a first, a second and a third material layer, and a second textile fabric, preferably a mesh, wherein the first textile fabric is arranged between the second and third material layer and the second textile fabric is arranged between the first and second material layer, wherein preferably the first material layer adjoins the valve channel, the second material layer is arranged further away from the valve channel than the first material layer and the third material layer is arranged further away from the valve channel than the second material layer, wherein particularly preferably the second textile fabric extends into the first end section and particularly preferably into the second end section, and wherein the pinch bar has a cross-section perpendicular and/or parallel to the conveyed direction, which tapers in the closing direction.

18. The pinch valve according to claim 17, wherein the pinch bar has a triangular cross-section perpendicular and/or parallel to the conveyed direction at least in sections, wherein the triangular cross-section is orientated such that one contact tip of the three tips of the triangular cross-section points in the closing direction, wherein the contact tip is preferably rounded with a radius, wherein a radius Rₛ of the contact tip of the triangular cross-section perpendicular to the conveyed direction is a minimum of 5 mm and a maximum of 20 mm, preferably a minimum of 7 mm and a maximum of 18 mm and/or wherein a radius Rₚ of the contact tip of the triangular cross-section parallel to the conveyed direction is a minimum of 2 mm and a maximum of 10 mm, preferably a minimum of 3 mm and a maximum of 7 mm, and wherein an opening angle α at the contact tip of the triangular cross-section perpendicular to the conveyed direction is a minimum of 85° and a maximum of 95° and/or wherein an opening angle ß at the contact tip of the triangular cross-section parallel to the conveyed direction is a minimum of 35° and a maximum of 65°.

19. The pinch valve according to claim 18, wherein the pinch bar has a triangular cross-section perpendicular to and parallel to the conveyed direction, wherein the contact tip of the triangular cross-section perpendicular to the conveyed direction has a radius Rₛ, wherein the contact tip of the triangular cross-section parallel to the conveyed direction has a radius Rₚ, wherein Rₛ #Rₚ, wherein the pinch bar has a triangular cross-section perpendicular to and parallel to the conveyed direction, wherein the contact tip of the triangular cross-section perpendicular to the conveyed direction has an opening angle α, wherein the contact tip of the triangular cross-section parallel to the conveyed direction has an opening angle β, wherein α≠β, wherein a drive to actuate the pinch bar is provided in the closing direction, wherein preferably the drive is a pneumatic drive, and wherein an opening is provided in the valve housing, via which the pressure in the valve housing can be adjusted.

20. The pinch valve according to claim 19, wherein at least some sections of the pinch bar have a coating which is arranged on a contact surface of the pinch bar, which contact surface comes into contact with the sleeve, wherein the valve housing has a cavity between the valve inlet and the valve outlet in which the sleeve is arranged, wherein the cavity is delimited by a housing wall, wherein the housing wall has a plurality of ribs, preferably a minimum of 4 and a maximum of 10 ribs, which ribs extend perpendicular to the conveyed direction from the housing wall in the direction of the sleeve into the cavity, and wherein a total length of the ribs in the conveyed direction corresponds to a minimum of 35%, preferably a minimum of 40% of the total length of the cavity in the conveyed direction.
